(19) United States
(12) Patent Application Publication
(10) Pub. No.: US 2015/0053291 A1
(43) Pub. Date: Feb. 26, 2015

(54) METHOD FOR MANUFACTURING A FLUID ROUTING COMPONENT BY LAYER-WISE BUILDUP

(71) Applicants: Airbus Operations GmbH, Hamburg (DE); Liebherr-Aerospace Lindenberg GmbH, Lindenberg (DE)

(72) Inventors: Gerhard Hummel, Hamburg (DE); Philipp Rapp, Immenstadt (DE); Lothar Kroll, Dresden (DE); Frank Schubert, Marienberg (DE); Martin Kausch, Burkhardtsdorf (DE)

(73) Assignees: Airbus Operations GmbH, Hamburg (DE); Liebherr-Aerospace Lindenberg GmbH, Lindenberg (DE)

(21) Appl. No.: 14/523,033

(22) Filed: Oct. 24, 2014

Related U.S. Application Data
(63) Continuation of application No. PCT/EP2013/058091, filed on Apr. 18, 2013.
(60) Provisional application No. 61/637,962, filed on Apr. 25, 2012.

(30) Foreign Application Priority Data
Apr. 25, 2012 (DE) 10 2012 008 369.6

(51) Int. Cl. F16K 27/10; B23K 26/34; B22F 3/24; B28B 13/02; B22F 3/10; B22F 5/10

(52) U.S. Cl. CPC F16K 27/10; B22F 3/10; B22F 5/10; B22F 3/24; B28B 13/0295; B23K 26/345; B22F 2003/247
USPC 137/884; 419/55; 419/28; 419/5; 264/497; 219/121.66; 251/368

(57) ABSTRACT

A method for manufacturing a fluid-leading component includes positioning a base element machined by a material-removing method with a planar upper face in a mounting support. The method at least includes the initial application of a layer section with predetermined dimensions of a particulate material in a predetermined region on the planar upper face of the base element; the heating of the layer section by a heat source in such a manner that the particles of the material within predetermined dimensions bond; and the application thereto and heating of at least one further layer section with predetermined dimensions of a particulate material in a predetermined region. In this way it is possible, in the generative manufacturing method, to obviate the need to provide support structures that subsequently have to be removed, and the base element is a functional part of the component to be manufactured.

### CROSS-REFERENCE TO RELATED APPLICATIONS

This application is a continuation of PCT application No. PCT/EP2013/058091, filed Apr. 18, 2013, which claims the benefit of the filing date of German Patent Application No. 10 2012 008 369.6 filed Apr. 25, 2012 and of U.S. Provisional Patent Application No. 61/637,962 filed Apr. 25, 2012, the disclosure of which applications is hereby incorporated herein by reference.

### TECHNICAL FIELD

The invention relates to a method for manufacturing a fluid-leading component by layer-wise buildup.

### BACKGROUND OF THE INVENTION

In particular the reduction of weight in order to improve the dynamic characteristics of a vehicle is a principal objective in the manufacture of components for vehicles. Especially in the case of commercial aircraft, considerable efforts are made to reduce the weight of components in order to achieve more economical operation by saving fuel. This effort is not limited to major components; instead, it applies likewise to all the installations and systems.

A method for manufacturing a control block in a lightweight metal construction is known from DE 10 2006 062 373 A1, in which a system of circuit elements comprises walls that are designed to withstand the loads encountered, which walls are, directly or with further elements, connected to form an interrelated structure and are all manufactured by means of a generative manufacturing process.

The generative manufacture of lightweight valve blocks suitable for commercial aircraft, which valve blocks comprise a system of interrelated circuit elements, in the state of the art requires support structures that in the manufacture of the valve block are also to be built up on the substrate plate and may be removed only after corresponding heat treatment of the valve block, because high intrinsic stress in the component would result in distortion and thus in the loss of dimensional stability.

The manufacture of fluid-leading components in layer-wise buildup may require considerable additional expenditure as a result of the support structures necessary in the state of the art. Thus both the duration of manufacture overall and the expenditure resulting from relatively intensive rework are increased, and consequently the economic efficiency of the component produced is reduced.

### BRIEF SUMMARY OF THE INVENTION

An aspect of the invention proposes a method for manufacturing a fluid-leading component, which method makes it possible to reduce the duration of manufacture, to reduce the expenditure arising therefrom, and to reduce the necessary rework, wherein nevertheless the manufactured component should, to the greatest extent possible, comprise the same mechanical and physical characteristics as does a component manufactured in some other manner.

In the method according to an aspect of the invention a flat base element with a planar upper face is positioned in a mounting support, after which the component is built up by the multiple carrying out of process steps that include at least: initially applying a layer section with predetermined dimensions of a particulate material in a predetermined region on the planar upper face of the base element; heating the layer section by means of a heat source in such a manner that the particles of the material within predetermined dimensions bond; and applying thereto and heating at least one further layer section with predetermined dimensions of a particulate material in a predetermined region.

Correspondingly, starting from a prefabricated and thus dimensionally very stable and precisely-formed base element, locally in a predetermined region in a fine layer an accumulation of particles from a selected material is made. The layer, which prior to each application of a further layer is already present, may thus be considered a base layer onto which a further layer section is applied. Accordingly, at the beginning of the method the base element is a base layer, while all the further material layers applied thereto form the base layer for the respective subsequent layer.

This generative manufacturing method may preferably be applied in the form of an ALM method (“Additive Layer Manufacturing”) in the construction of hydraulic systems, valve blocks and other particularly light-weight hydraulic devices, in particular for use in commercial aircraft. This results layer-by-layer in a three-dimensional component of any desired shape that may be relatively complex. The materials characteristics of such a product are equal or superior to a cast component. In particular a laser is suitable as a heat source, and consequently as a special form of an ALM method an SLM method (“Selective Laser Melting”) may be applied. It is advantageous in the method according to the invention to use powdery steel, stainless steel, aluminum alloys, titanium alloys or other meltable materials. For certain application fields the use of cobalt alloys and nickel alloys is also advantageous. For application in vehicles, and in particular in commercial aircraft, in particular powdery AlSi10Mg or TiAl6V4 is suitable.

The layer thicknesses depend on several factors such as, among other things, the output of the heat source used, the required accuracy, the materials characteristics and the reworkability. The smallest possible base area of a layer section depends on the geometric extension of the heat source. Thus, with particularly fine heat sources, for example a laser beam, a particularly fine structure may be manufactured. By matching the respective contour to be melted on, the process may be repeated until the component has been completed.

Preferably, the base element may be machined or manufactured in a machining method so that it comprises precise dimensions and furthermore a suitable surface quality for use as an integral component or for the generative buildup of the component to be manufactured. In this arrangement the necessary functions of the component to be manufactured may be provided by the base element, wherein this includes, for example, the provision of flanges or other mating surfaces or functional surfaces.

In an advantageous embodiment of the invention the particulate material is a metallic material. With the aforesaid it is possible to manufacture fluid-leading components of high strength and in particular of high compressive strength for use in hydraulic systems. In order to achieve a particularly light weight, aluminum alloys such as AlSi10Mg or titanium alloys such as TiAl6V4 are particularly suitable. Subsequent heat treatment for homogenizing the microstructure of the metal further significantly increases the materials characteristics. Positioning may, furthermore, comprise clamping, screwing or some other fastening method.

In another advantageous embodiment of the invention the particulate material is a ceramic material, for example zirconium oxide (ZrO₂) or aluminum oxide (Al₂O₃). The compressive strength is in line with that of components manufactured from metallic particles, wherein the advantages of the ceramic material relate in particular to the significantly reduced weight.

In an advantageous embodiment, after completion of the layer-wise buildup the manufactured component is heat treated in a heat treatment device. In this manner the microstructure of the component manufactured may be influenced in such a manner that it is uniform over the entire spatial extension of the component so that any stress arising during manufacture of the component is eliminated. This may, for example, comprise heating to a target temperature, holding a target temperature, and the targeted reduction in the temperature.

In an advantageous embodiment the manufactured body is partially reworked so that, preferably, functional surfaces and mating surfaces are given a machined finish. In this arrangement the base element may be used as a reference standard. In this manner the dimensional stability of the entire component may be ensured. For example, reworking may comprise grinding, drilling, polishing or other types of commonly-used machining methods.

In an advantageous embodiment the base element is made from a plate-shaped material. In this arrangement, manufacture may, in particular, comprise cutting, drilling, grinding, polishing, turning and milling. The planar surface should be designed in such a manner that very good adhesion of the particulate material is ensured. This may, in particular, take place by suitable corundum blasting with particle sizes ranging from 600 to 850 μm. In this manner particularly good connection of the generatively produced component may be achieved.

In an advantageous embodiment, by heating the layer section that has been applied in the predetermined region to the planar upper face of the base element this layer section is connected to the base element by means of the heat source so that the base element, at least in part, forms part of the component. The combination of a finished component and a generatively produced component section combines the advantages of two manufacturing methods. In particular in the case of flanges or other functional surfaces or mating surfaces it is possible in this manner to do without surface treatment that is otherwise necessary for such components.

An advantageous embodiment further comprises the step of providing at least one hole in the base element, wherein applying the layer section of a particulate material takes place at least in the vicinity of each hole of the planar upper face of the base element, and heating the layer section by means of the heat source takes place in such a manner that the particles of the material bond in a ring-shaped manner around each hole, and the inner surface of each hole together with the layer section arranged around it in each case forms a pipe section of the component. Accordingly, a pipe section formed in any desired shape may follow on from an already existing hole in the base element, which pipe section ends precisely in the base element and in the hole located in the aforesaid.

In an advantageous embodiment the at least one hole is drilled in the base element. This makes possible a precise connection of the fluid-leading component to a fluid source or fluid sink, and preferably it is not necessary to rework the hole after it has been machined.

The invention further relates to a fluid-leading component in which a system of circuit elements are connected to form an interrelated structure and are all manufactured by means of a generative manufacturing method on a base element with a planar surface. In a particularly advantageous embodiment the component is a control block for a pneumatic or hydraulic circuit.

In an advantageous embodiment the base element, at least on the planar surface, comprises a material that is identical to the material of the layer sections manufactured by means of the generative manufacturing method. This ensures a firm connection between the generatively manufactured component parts and the base element.

In a further advantageous embodiment the base element comprises at least one hole, wherein the inner surface of each hole together with ring-shaped layer sections manufactured around each hole by means of the generative manufacturing method in each case forms a pipe section of the component. As explained above, thus pipe sections formed in any desired manner may be provided, which pipe sections connect to the base element.

In a preferred embodiment the at least one hole is furthermore a drill hole that as a result of metal-removing drilling with a short processing time achieves a predetermined surface quality and dimensional stability.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a sequence of several manufacturing steps of a method according to the invention.

FIGS. 2a to 2d each show a partial section of a finished component.

### DETAILED DESCRIPTION

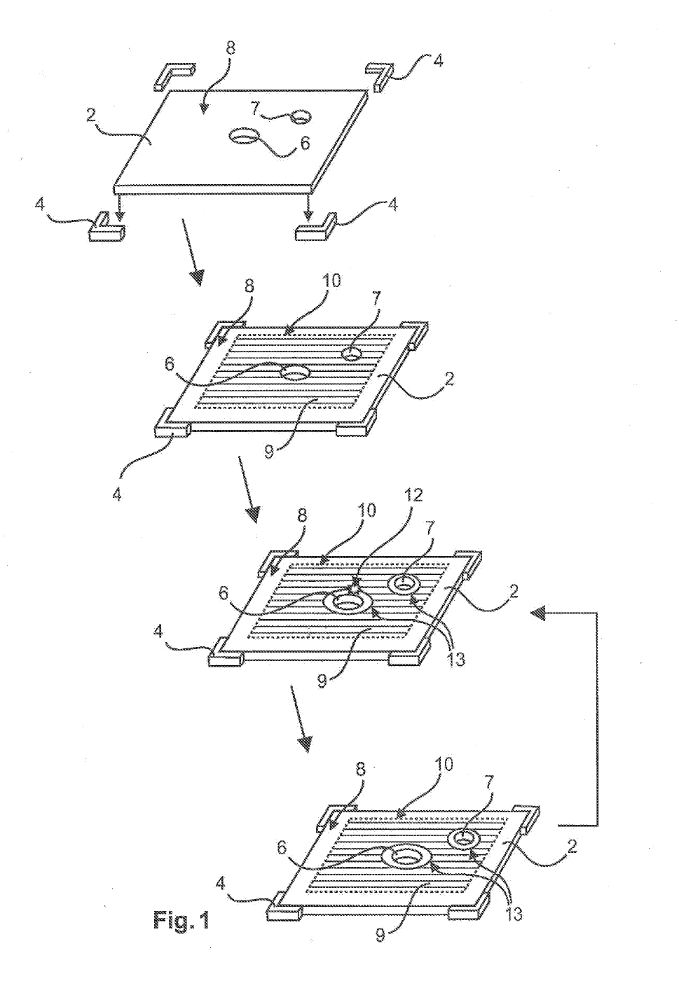

FIG. 1 shows a diagrammatic view of the features of the method according to an aspect of the invention for manufacturing a fluid-leading component.

Initially a base element 2 is positioned as an insert, wherein this may comprise clamping in clamping mounts 4 of a device for carrying out a generative manufacturing method. In this arrangement it is preferable that the fixed base element 2 may take up the intrinsic thermal stress resulting from the process while experiencing almost no distortion. This may on the one hand be achieved by the rigidity of the base element 2 itself, and on the other hand also by low-distortion fixing. The base element 2 may be made by machining from a plate-shaped material and could comprise one or several, preferably drilled, holes 6 and 7 on which at a later stage system elements are generatively built up. In the exemplary embodiment shown the inner surfaces of the holes 6 and 7 already form part of an inner surface of a pipe section, which is suitable for leading fluid, of the component 14, 16 to be manufactured. The layers 13 to be built up in the first and subsequent process steps form, in particular in a ring-shaped enclosing manner, on the holes 6 and 7 in order to form with the inner surfaces of the holes 6 and 7 a pipe section of the component 14, 16 to be manufactured. The base element may thus already be preprocessed or finished, wherein in particular an upper surface 8 should be as planar as possible. Furthermore, a surface roughness of R_{z}≈30 μm to 90 μm suggests itself in order to allow for adequate adhesion of the material.

Subsequently a fine powder layer 10 from a metallic material, for example AlSi10Mg, is applied in a predetermined region 9 to the base element 2 and is heated by means of a heat source, for example a laser beam 12, along a predetermined contour. Depending on the characteristics of the powdery material 10, its state is altered. With the use of a metallic powdery material, local melting occurs so that the particles over which the heat source 12 moves bond and connect to the surface 8 of the base element 2 so that discrete layers 13 of the component to be manufactured arise. If the particulate material is a ceramic material, it is advantageous if a base element 2 from an identical material is selected. As a result of the energy input the particles generally bond by diffusion processes (selective laser sintering).

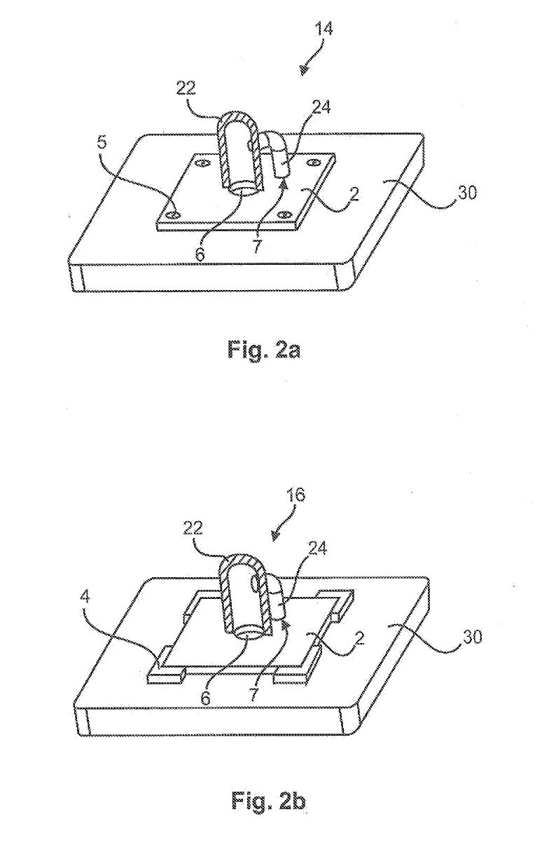

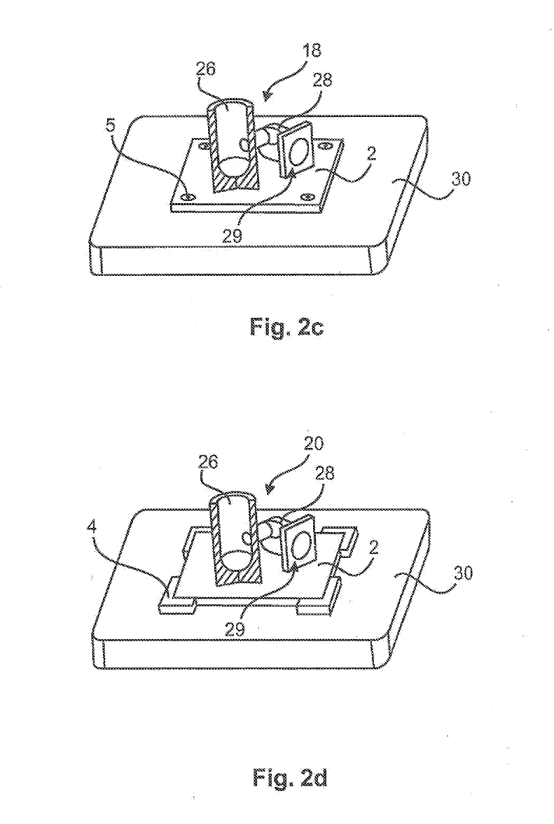

On completion of manufacturing a discrete layer of a specific layer thickness, by means of the application of a further powdery material, the next layer may be manufactured, which layer connects to the underlying layer as a result of contour-guided heating, and consequently, for example, one of the control blocks 14, 16, 18, 20 shown in FIGS. 2a to 2d with structural elements 22-28 results. The control blocks 14 and 16 shown in FIGS. 2a and 2b build up on a base element 2 with holes 6 and 7, while the control blocks 18 and 20 from FIGS. 2c and 2d do not require this. Furthermore, by screwing with the use of screwing means 5, the base elements 2 from FIGS. 2a and 2c are fastened to a support 30 of a manufacturing device (not shown), while the base elements 2 from FIGS. 2b and 2d are fastened to the support 30 by means of clamping with the use of clamping mounts 4.

The method according to an aspect of the invention provides a special feature in that it is not necessary to support structural elements 22-28 by means of support structures to be manufactured with the use of the generative layer construction method. This also obviates the need for any subsequent rework at this location. In a subsequent step the entire body may be heat treated in order to harmonize the microstructure. Furthermore, this may be followed by additional machining, in particular or preferably exclusively on functional surfaces and mating surfaces 29, as shown in FIGS. 2c and 2d.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

1. A method for manufacturing a fluid-leading component comprising:
positioning of a base element processed by a shaping method, with a planar upper face in a mounting support;
initially applying a layer section with predetermined dimensions of a particulate material in a predetermined region on the planar upper face of the base element;
heating the layer section by a heat source in such a manner that the particles of the material within predetermined dimensions bond; and
applying thereto and heating at least one further layer section with predetermined dimensions of a particulate material in a predetermined region.

2. The method of claim 1, wherein the particulate material is a metallic material.

3. The method of claim 1, wherein the particulate material is a ceramic material.

4. The method of claim 1, wherein after completion of the layer-wise buildup the manufactured component is heat treated in a heat treatment device.

5. The method of claim 1, wherein the built-up component is subsequently machined.

6. The method of claim 5, wherein the component is machined exclusively on functional surfaces and mating surfaces.

7. The method of claim 1, wherein the base element is manufactured from a plate-shaped material.

8. The method of claim 1, wherein by heating the layer section that has been applied in the predetermined region to the planar upper face of the base element the layer section is connected to the base element so that the base element, at least in part, forms part of the component.

9. The method of claim 1, further comprising:
providing at least one hole in the base element,
wherein applying the layer section of a particulate material takes place at least in the vicinity of each hole of the planar upper face of the base element, and heating the layer section takes place in such a manner that the particles of the material bond in a ring-shaped manner around each hole, and the inner surface of each hole together with the layer section arranged around the hole in each case forms a pipe section of the component.

10. The method of claim 9, wherein the at least one hole is drilled in the base element.

11. A fluid-leading component, comprising a system of bonded circuit elements that are all manufactured by a layer-by-layer generative manufacturing method on a base element with a planar surface, and the base element at least in part form part of the component.

12. The fluid-leading component of claim 11, wherein the base element, at least on the planar surface, comprises a material that is identical to the material of the layer sections manufactured by the generative manufacturing method.

13. The fluid-leading component of claim 11, wherein the base element comprises at least one hole, wherein the inner surface of each hole together with ring-shaped layer sections manufactured around each hole by means of the generative manufacturing method in each case forms a pipe section of the component.

14. The fluid-leading component of claim 13, wherein the at least one hole is a drill hole.

15. The fluid-leading component of claim 11, wherein the component is a control block for a pneumatic or hydraulic circuit.
